(19) United States
(12) Patent Application Publication
(10) Pub. No.: US 2025/0094739 A1
(43) Pub. Date: Mar. 20, 2025

(54) TRAINING METHOD AND APPARATUS FOR FULL ATOMIC STRUCTURE PREDICTION MODEL, AND ELECTRONIC DEVICE

(71) Applicant: BEIJING BAIDU NETCOM SCIENCE TECHNOLOGY CO., LTD., Beijing (CN)

(72) Inventors: Zhongjun He, Beijing (CN); Hua Wu, Beijing (CN); Haifeng Wang, Beijing (CN)

(73) Assignee: BEIJING BAIDU NETCOM SCIENCE TECHNOLOGY CO., LTD., Beijing (CN)

(21) Appl. No.: 18/968,830

(22) Filed: Dec. 4, 2024

(30) Foreign Application Priority Data
Mar. 5, 2024 (CN) 202410251396.0

(51) Int. Cl. G06F 40/58; G06F 40/51

(52) U.S. Cl. CPC G06F 40/58; G06F 40/51

(57) ABSTRACT

An information processing method. The method includes obtaining a first bilingual sentence pair, in which the first bilingual sentence pair comprises a source language sentence and a target language sentence; and obtaining a distilled second bilingual sentence pair by distilling a first language sentence in the first bilingual sentence pair based on a large language model (LLM), in which the first language sentence is the source language sentence or the target language sentence.

### CROSS-REFERENCE TO RELATED APPLICATIONS

The present application is based on and claims the priority of Chinese patent application No. 2024102513960 filed on Mar. 5, 2024, the entire contents of which are incorporated herein by reference.

### TECHNICAL FIELD

The present disclosure relates to the field of artificial intelligence technology, specifically to the field of machine translation, deep learning and large language models, and in particular to an information processing method and apparatus, an electronic device and a storage medium.

### BACKGROUND

Machine translation is a discipline that uses computers to translate human languages, which is a core technology that breaks through language barriers. Currently, neural network machine translation is the mainstream technology. Compared with traditional machine translation methods, the neural network machine translation has made a significant improvement in translation quality.

At present, a large language model can demonstrate powerful understanding, generation, memory and reasoning capabilities, and also performs well in cross-language machine translation tasks. However, the large language model also faces the challenges of large number of parameters and high computing power requirements. In terms of the machine translation technology, the cost of directly using the large language model is relatively high.

### SUMMARY

The present disclosure provides an information processing method and apparatus, an electronic device and a storage medium.

According to a first aspect of the present disclosure, an information processing method is provided, including:
obtaining a first bilingual sentence pair, in which the first bilingual sentence pair comprises a source language sentence and a target language sentence; and
obtaining a distilled second bilingual sentence pair by distilling a first language sentence in the first bilingual sentence pair based on a large language model (LLM), in which the first language sentence is the source language sentence or the target language sentence.

According to a second aspect of the present disclosure, an electronic device is provided, including: at least one processor; and a memory communicatively coupled to the at least one processor. The memory stores instructions executable by the at least one processor, when the instructions are executed by the at least one processor, the at least one processor is enabled to implement the method described in the first aspect of the embodiments.

According to a third aspect of the present disclosure, a non-transitory computer-readable storage medium having computer instructions stored thereon is provided. The computer instructions are configured to enable a computer to implement the method described in the first aspect of the embodiments.

According to a fourth aspect of the present disclosure, a computer program product is provided, including computer programs. When the computer programs are executed by a processor, steps of the method described in the first aspect of the embodiments are implemented.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic flowchart of an information processing method provided in an embodiment of the disclosure.

FIG. 2 is a schematic flowchart of an information processing method provided in another embodiment of the disclosure.

FIG. 3 is a schematic flowchart of an information processing method provided in another embodiment of the disclosure.

FIG. 4 is a schematic diagram of an information processing method provided in an embodiment of the present disclosure.

FIG. 5 is a schematic flowchart of an information processing method provided in an embodiment of the present disclosure.

FIG. 6 is a block diagram of an information processing apparatus provided in an embodiment of the present disclosure.

FIG. 7 is a block diagram of an electronic device used to implement the training method for a full atomic structure prediction model according to embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Artificial Intelligence (AI) is a new technical science that studies and develops theories, methods, technologies and application systems for simulating, extending and expanding human intelligence. The AI technology can simulate the information process of human consciousness and thinking. The main goal of artificial intelligence research is to enable machines to perform complex tasks that usually require human intelligence.

Machine translation, also known as automatic translation, is the process of using computers to convert a natural language (source language) into another natural language (target language). The development of the machine translation technology has always closely followed the development of computer technology, information theory, linguistics and other disciplines.

Deep Learning is an information research direction in the field of machine learning. It is the inherent laws and representation levels of learning sample data. The information obtained in the learning process is of great help in the interpretation of data such as text, images and sounds. The ultimate goal is to enable machines to have analytical learning capabilities like humans and to be capable of recognizing data such as text, images and sounds.

A Large Language Model (LLM) is an artificial intelligence model designed to understand and generate language. The LLM can perform a wide range of tasks, including text summarization, translation, and sentiment analysis. The LLM is characterized by its large scale, containing billions or even trillions of parameters, to learn complex patterns in language.

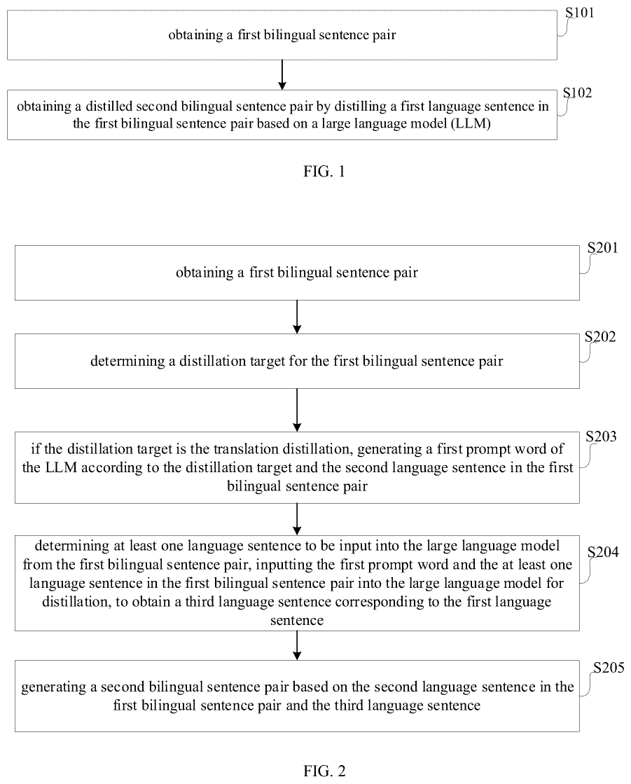

FIG. 1 is a schematic flowchart of an information processing method provided in an embodiment of the present disclosure. As shown in FIG. 1, the method includes the following steps.

At step S101, a first bilingual sentence pair is obtained.

The first bilingual sentence pair includes a source language sentence and a target language sentence.

The source language sentence is a sentence to be translated, and the target language sentence is a translated sentence. For example, if the translation requirement is to translate a Chinese sentence into an English sentence, the original Chinese sentence to be translated is the source language sentence, and the translated English sentence is the target language sentence.

In some implementations, the first bilingual sentence pair can be read from a database or collected from the Internet. It is understandable that the source language can be an existing language such as Chinese, English, Korean, or Japanese; accordingly, the target language can also be an existing language such as Chinese, English, Korean, or Japanese.

In some implementations, the source language sentence and the target language sentence in the first bilingual sentence pair are paired sentences, that is, the source language sentence and the target language sentence are the same sentence expressed in different languages. For example, the source language sentence is A expressed in Chinese, and the target language sentence is A expressed in English.

At step S102, a first language sentence in the first bilingual sentence pair is distilled based on a large language model (LLM) to obtain a distilled second bilingual sentence pair.

The first language sentence is the source language sentence or the target language sentence.

The purpose of distillation is to extract features and capabilities from the model and compress them into a form that can be processed at a lower cost. Optionally, the distillation in this embodiment can be translation distillation or optimization distillation performed for the sentence, and the second bilingual sentence pair with a better translation quality can be obtained through the two methods of distillation.

In some implementations, the translation distillation refers to translating sentences and extracting a translation capability of the large language model. It is understandable that after translating the first language sentence in the first bilingual sentence pair based on the large language model, a translated sentence can be obtained, and the translated sentence and the sentence input into the large language model form the second bilingual sentence pair.

As an example, assume that the first bilingual sentence pair includes a source language sentence A and a target language sentence B, and the source language sentence A in the first bilingual sentence pair is input into the large language model for distillation to obtain a translated sentence C. In this case, the second bilingual sentence pair may include the translated sentence C and the source language sentence A.

In other implementations, the distillation in this embodiment can also be used to optimize or polish sentences, that is, the optimization distillation is to optimize or polish the first language sentence in the first bilingual sentence pair to obtain a sentence that is more accurately and smoother.

As an example, assume that the first bilingual sentence pair includes a source language sentence A and a target language sentence B, and the target language sentence B in the first bilingual sentence pair is input into the large language model for distillation to obtain an optimized sentence D after optimization and polishing. In this case, the second bilingual sentence pair may include the optimized sentence D and the target language sentence B.

In the embodiment of the present disclosure, the first bilingual sentence pair including the source language sentence and the target language sentence is obtained, and the first bilingual sentence pair is distilled through a large language model to obtain the second bilingual sentence pair after distillation performed by the large language model. After the second bilingual sentence pair is distilled by the large language model, the translation effect and expression of the sentence are better, thereby ensuring the translation quality.

FIG. 2 is a schematic flowchart of an information processing method provided in another embodiment of the present disclosure. As shown in FIG. 2, the method includes the following steps.

At step S201, a first bilingual sentence pair is obtained.

In the present disclosure, step S201 can be implemented using any manner in embodiments of the present disclosure, and will not be elaborated here.

At step S202, a distillation target for the first bilingual sentence pair is determined.

The distillation target is translation distillation or polishing distillation.

In some implementations, if the distillation target is the translation distillation, the main task of the large language model is to accurately translate sentences. If the distillation target is the polishing distillation, the main task of the large language model is to polish and optimize sentences to achieve a better expression effect.

At step S203, if the distillation target is the translation distillation, a first prompt word of the large language model is generated according to the distillation target and a second language sentence in the first bilingual sentence pair.

Optionally, the second language sentence can be a source language sentence or a target language sentence. If the first language sentence is the source language sentence, the second language sentence is the target language sentence, and correspondingly, if the first language sentence is the target language sentence, the second language sentence is the source language sentence.

In some implementations, if the second language sentence is the source language sentence, the translation distillation is determined as a target language distillation, the second language sentence is determined as a language sentence to be translated, and the first prompt word for translating the language sentence to be translated into a target language is generated. That is, if the second language sentence is the source language sentence, the translation distillation is the target language distillation, the source language sentence is determined as the language sentence to be translated, and the first prompt word for translating the source language sentence into a source language is generated, for example, the first prompt word is “translate the source language sentence into the target language”.

Optionally, if the second language sentence is the target language sentence, the translation distillation is determined as a source language distillation, the second language sentence is determined as a language sentence to be translated, and a first prompt word for translating the language sentence to be translated into the source language is generated. That is, if the second language sentence is the target language sentence, the translation distillation is the source language distillation, the target language sentence is determined as the language sentence to be translated, and a first prompt word for translating the target language sentence into the source language is generated, for example, the first prompt word is “translate the target language sentence into the source language”, and the prompt word is used to guide the large language model to output a third language sentence with a better translation effect.

At step S204, at least one language sentence to be input into the large language model is determined from the first bilingual sentence pair, the first prompt word and the at least one language sentence in the first bilingual sentence pair are input into the large language model for distillation, to obtain a third language sentence corresponding to the first language sentence.

Optionally, a second language sentence may be determined from the first bilingual sentence pair as a language sentence to be input into the large language model.

It can be understood that when the first language sentence is the source language sentence, the second language sentence is the target language sentence, and the translation distillation is the source language distillation, the target language sentence (language sentence to be translated) and the first prompt word are input into the large language model to obtain the third language sentence corresponding to the first language sentence. It can be understood as reconstruction of the first language sentence (source language sentence), that is, the second language sentence (target language sentence) is re-translated by the large language model to obtain the source language sentence corresponding to the first language sentence (original source language sentence). Accordingly, when the first language sentence is the target language sentence, the second language sentence is the source language sentence, and the translation distillation is the target language distillation, the source language sentence (language sentence to be translated) and the first prompt word are input into the large language model to obtain the third language sentence corresponding to the first language sentence, that is, the second language sentence (source language sentence) is re-translated by the large language model to obtain the target language sentence corresponding to the first language sentence (original target language sentence).

At step S205, a second bilingual sentence pair is generated based on the second language sentence in the first bilingual sentence pair and the third language sentence.

If the first language sentence is the source language sentence, then the second language sentence is the target language sentence. If the first language sentence is the target language sentence, then the second language sentence is the source language sentence.

It can be understood that after the first prompt word and the second language sentence are input into the large language model, the third language sentence corresponding to the first language sentence is obtained. In this case, the first language sentence and the third language sentence are different expressions of the same language. For example, the first language sentence X and the second language sentence Y are a group of sentences including Chinese and English sentence that can be translated to each other. The large language model obtains the third language sentence X1 in Chinese by re-translating the second language sentence Y in English. In this case, the first language sentence X in Chinese and the third language sentence X1 in Chinese are both translations of the second language sentence Y in English. The third language sentence X1 and the second language sentence Y form the second bilingual sentence pair.

In the embodiment of the present disclosure, when the distillation target is the translation distillation, the translation distillation is determined as the target language distillation or the source language distillation through the second language sentence, so as to achieve multi-terminal language distillation. The corresponding first prompt word is determined, the second language sentence and the first prompt word are input into the large language model, to obtain the third language sentence corresponding to the first language sentence, i.e., the third language sentence after reconstruction of the first language sentence. The third language sentence and the original second language sentence form a new second bilingual sentence pair. In this way, the re-translation of the large language model ensures the translation quality during translation and avoids the influence of poor translation quality.

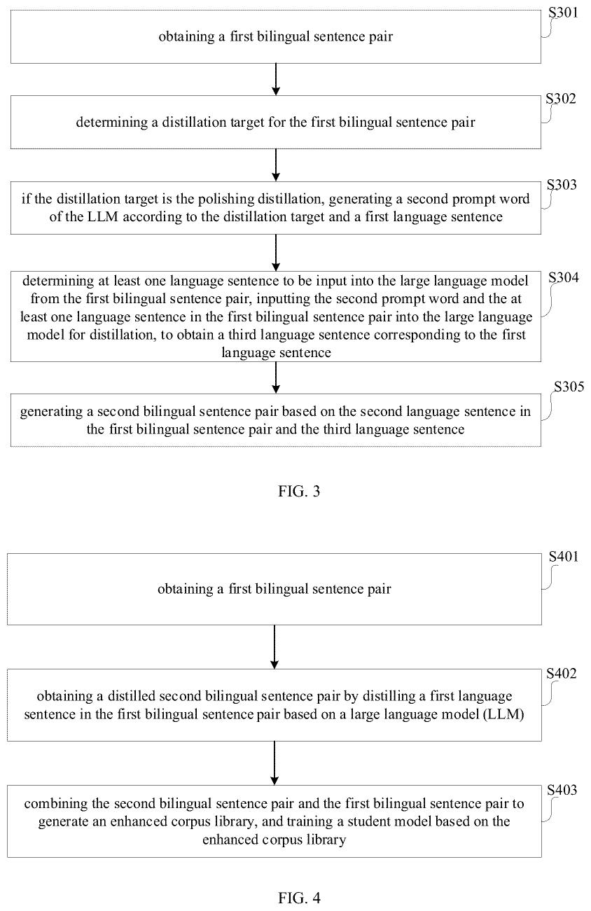

FIG. 3 is a schematic flowchart of an information processing method provided in another embodiment of the present disclosure. As shown in FIG. 3, the method includes the following steps.

At step S301, a first bilingual sentence pair is obtained.

In the present disclosure, step S301 can be implemented using any manner in embodiments of the present disclosure, and will not be elaborated here.

At step S302, a distillation target for the first bilingual sentence pair is determined.

In the present disclosure, step S302 can be implemented using any manner in embodiments of the present disclosure, and will not be elaborated here.

At step S303, if the distillation target is the polishing distillation, a second prompt word of the large language model is generated according to the distillation target and a first language sentence.

Optionally, the first language sentence can be used as the language sentence to be polished, and the second prompt word for polishing the language sentence to be polished can be generated. That is, when the distillation target is the polishing distillation, it is required to polish sentences, the first language sentence in the first bilingual sentence pair is used as the sentence to be polished, and the second prompt word for polishing the sentence to be polished can be generated.

In some implementations, the first language sentence may be a source language sentence or a target language sentence. When the first language sentence is the source language sentence, the second prompt word may be “polish the source language sentence according to source language expression habits to make it more fluent”. When the first language sentence is the target language sentence, the second prompt word may be “polish the target language sentence according to target language expression habits to make it more fluent”. The large language model is guided to polish the first language sentence based on the second prompt word.

At step S304, at least one language sentence to be input into the large language model is determined from the first bilingual sentence pair, the second prompt word and the at least one language sentence in the first bilingual sentence pair are input into the large language model for distillation, to obtain a third language sentence corresponding to the first language sentence.

Optionally, the first language sentence and its second prompt word may be input into the large language model for polishing and distillation to obtain a polished sentence, that is, the third language sentence corresponding to the first language sentence.

Optionally, the two language sentences in the first bilingual sentence pair and their corresponding second prompt words can be input into the large language model, and the large language model polishes and distills the first language sentence and the second language sentence respectively to obtain polished sentences. That is, the first language sentence and the second language sentence in the first bilingual sentence pair are both used as language sentences to be input into the large language model, and the second language sentence and the first language sentence in the first bilingual sentence pair and their corresponding second prompt words are all input into the large language model, and the third language sentence and the second language sentence corresponding to the first language sentence are output, so as to achieve the purpose of polishing the sentences and make the sentence expressions clearer and more fluent.

At step S305, a second bilingual sentence pair is generated based on the second language sentence in the first bilingual sentence pair and the third language sentence.

It can be understood that the first language sentence in the first bilingual sentence pair is a sentence on which distillation is performed, and the third language sentence is a sentence obtained after polishing and distillation by the large language model. The expression of the third language sentence is clearer and smoother. Therefore, the third language sentence and the second language sentence can form the second bilingual sentence pair. The second bilingual sentence pair includes sentences that has been polished, and the expressions are clearer and smoother.

In the present disclosure, step S305 can be implemented using any manner in embodiments of the present disclosure, and will not be elaborated here.

In the embodiment of the present disclosure, when the distillation target is the polishing distillation, the third language sentence with a clearer expression is obtained by polishing and distilling the first language sentence, and the first language sentence can be the source language sentence or the target language sentence. The distillation and polishing of the large language model improve the expression and translation quality of the sentence, so that a high-quality second bilingual sentence pair is generated based on the third language sentence and the second language sentence, thereby ensuring the translation quality.

FIG. 4 is a schematic flowchart of an information processing method provided in another embodiment of the present disclosure. As shown in FIG. 4, the method includes the following steps.

At step S401, a first bilingual sentence pair is obtained.

In the present disclosure, step S401 can be implemented using any manner in embodiments of the present disclosure, and will not be elaborated here.

At step S402, a first language sentence in the first bilingual sentence pair is distilled based on a large language model (LLM) to obtain a distilled second bilingual sentence pair.

In the present disclosure, step S402 can be implemented using any manner in embodiments of the present disclosure, and will not be elaborated here.

At step S403, the second bilingual sentence pair and the first bilingual sentence pair are combined to generate an enhanced corpus library, and a student model is trained based on the enhanced corpus library.

It can be understood that the first bilingual sentence pair is an original sentence pair obtained through a database, and the second bilingual sentence pair is a sentence pair with better translation quality obtained after distillation of the large language model. The first bilingual sentence pair and the second bilingual sentence pair are combined to obtain the enhanced corpus library. The enhanced corpus library includes multiple corpus groups (i.e., multiple bilingual sentence pairs), each of which includes a source language sentence and a target language sentence. The student model is trained by the enhanced corpus library, so that the student model can learn a translation capability of the large language model to ensure the translation effect of the student model on the sentence.

Optionally, the student model can be a language model with fewer parameters (compared to the large language model) or a traditional neural network model, such as a long short-term memory network (LSTM), Transformer, etc. It can be understood that a teacher model in the embodiment is a large language model with a large number of parameters. The translation capability of the large language model is transferred to the student model through distillation, so that the student model has the translation capability of the large language model, while retaining the characteristics of the student model, such as high efficiency and easy deployment.

In some implementations, quality assessment can be performed on the corpus in the enhanced corpus library; based on quality assessment information of the corpus, screening is performed on the corpus in the enhanced corpus library to obtain a target corpus library; and the student model is trained based on the target enhanced corpus library. In other words, the quality assessment is performed on the corpus in the enhanced corpus library, and the corpora with better quality are selected to obtain the target corpus library, and the student model is trained with the target corpus library to obtain a student model that retains the translation capability of the large language model.

Optionally, the purpose of performing quality assessment on the corpus in the enhanced corpus library is to assess the translation quality of the corpus, that is, the quality assessment of a group of corpora characterizes the correspondence between the source language and the target language in the corpora. The closer the translations of the source language and the target language, the better the quality of the corpora.

In some implementations, the quality assessment information of the corpus may be a quality value of the corpus, and a higher quality value indicates a better translation quality of the corpus. The process of performing screening on the corpus in the enhanced corpus library based on the quality assessment information may include: determining a corpus group corresponding to the same source language sentence; and screening at least one target corpus corresponding to the same source language sentence from the corpus group according to the quality assessment information of each corpus in the corpus group.

As an example, for a source language sentence A, corpus a and corpus b corresponding to the source language sentence A are determined. The corpus a and the corpus b are respectively the first bilingual sentence pair and the second bilingual sentence pair. Quality assessment information of the corpus a and quality assessment information of the corpus b are obtained respectively, and the target corpus is determined based on the quality assessment information.

Optionally, the quality assessment information of each corpus in the corpus group can be compared to determine the corpus with the highest quality as the target corpus; or, the corpora in the corpus group can be sorted according to the quality assessment information of each corpus in the corpus group, and the corpus ranked at the top can be selected as the target corpus; or, the quality assessment information of each corpus in the corpus group can be compared with a preset quality assessment threshold, and the corpus with quality assessment information greater than or equal to the preset quality assessment threshold can be selected as the target corpus.

As an example, for the corpus group corresponding to the source language sentence A (including corpus a and corpus b), the corpus with the highest quality between the corpus a and the corpus b is selected as the target corpus; or when the corpus group includes more corpora, the quality assessment information of all corpora is sorted from largest to smallest, and the corpus ranked at the top is selected as the target corpus; the quality assessment information of each corpus in the corpus group can also be compared with the preset quality assessment threshold, and the corpus with quality assessment information greater than or equal to the quality assessment threshold is selected as the target corpus. The specific method for selecting the target corpus is not limited. It can be understood that the purpose of selecting the target corpus is to screen out corpora with better translation quality, and the target corpus library composed of the target corpora is used as training samples, that is, the corpora with better translation quality are used as training samples to ensure the training effect of the student model, so that the student model can learn the translation capability of the large language model.

In the embodiment of the present disclosure, after obtaining the second bilingual sentence pair, based on the comparison between the second bilingual sentence pair and the first bilingual sentence pair, a target corpus with better translation quality is determined, and the target corpus library is generated based on the target corpus to train the student model, so that the student model can learn the translation capability of the large language model. The translation quality of the student model is ensured using the target corpus with better translation quality, thereby improving resource utilization, and reducing the cost of directly deploying the large model.

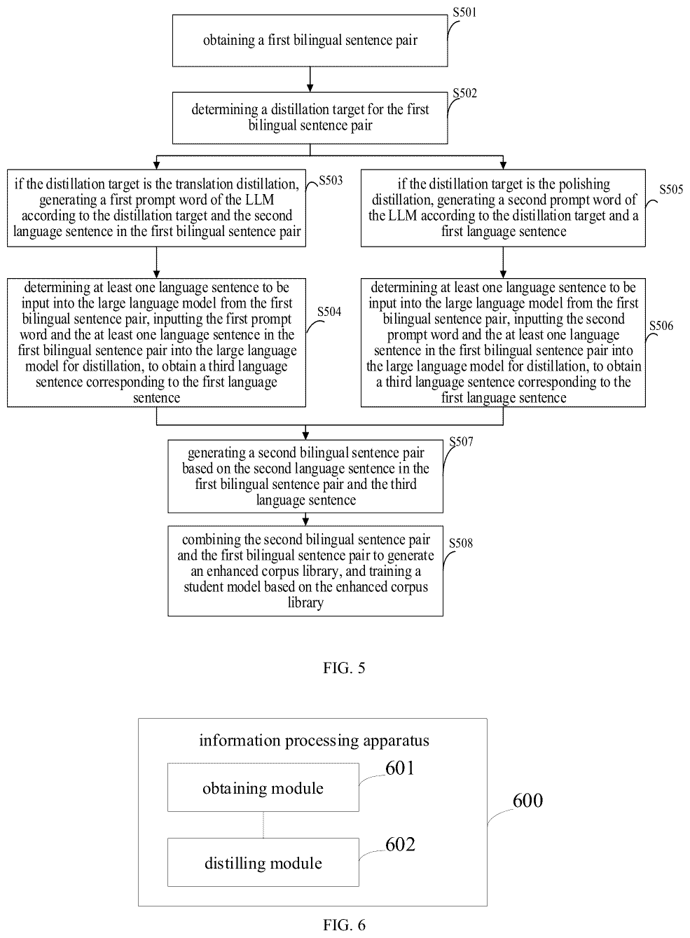

FIG. 5 is a schematic flowchart of an information processing method provided in another embodiment of the present disclosure. As shown in FIG. 5, the method includes the following steps.

At step S501, a first bilingual sentence pair is obtained.

In the present disclosure, step S501 can be implemented using any manner in embodiments of the present disclosure, and will not be elaborated here.

At step S502, a distillation target for the first bilingual sentence pair is determined.

In the present disclosure, step S502 can be implemented using any manner in embodiments of the present disclosure, and will not be elaborated here.

At step S503, if the distillation target is the translation distillation, a first prompt word of the large language model is generated according to the distillation target and a second language sentence in the first bilingual sentence pair.

In the present disclosure, step S503 can be implemented using any manner in embodiments of the present disclosure, and will not be elaborated here.

At step S504, at least one language sentence to be input into the large language model is determined from the first bilingual sentence pair, the first prompt word and the at least one language sentence in the first bilingual sentence pair are input into the large language model for distillation, to obtain a third language sentence corresponding to the first language sentence.

In the present disclosure, step S504 can be implemented using any manner in embodiments of the present disclosure, and will not be elaborated here.

At step S505, if the distillation target is the polishing distillation, a second prompt word of the large language model is generated according to the distillation target and a first language sentence.

In the present disclosure, step S505 can be implemented using any manner in embodiments of the present disclosure, and will not be elaborated here.

At step S506, at least one language sentence to be input into the large language model is determined from the first bilingual sentence pair, the second prompt word and the at least one language sentence in the first bilingual sentence pair are input into the large language model for distillation, to obtain a third language sentence corresponding to the first language sentence.

In the present disclosure, step S506 can be implemented using any manner in embodiments of the present disclosure, and will not be elaborated here.

At step S507, a second bilingual sentence pair is generated based on the second language sentence in the first bilingual sentence pair and the third language sentence.

In the present disclosure, step S507 can be implemented using any manner in embodiments of the present disclosure, and will not be elaborated here.

At step S508, the second bilingual sentence pair and the first bilingual sentence pair are combined to generate an enhanced corpus library, and a student model is trained based on the enhanced corpus library.

In the present disclosure, step S508 can be implemented using any manner in embodiments of the present disclosure, and will not be elaborated here.

In the embodiment of the present disclosure, the first bilingual sentence pair including the source language sentence and the target language sentence is obtained, and the first bilingual sentence pair is distilled through the large language model to obtain the second bilingual sentence pair after distillation by the large language model. After the second bilingual sentence pair is distilled by the large language model, the translation effect and expression of the sentences are better, thereby ensuring the translation quality. The student model is trained based on the corpus library with better translation quality to ensure that the student model can learn the translation capability of the large language model and provide better translation effect.

FIG. 6 is a block diagram of an information processing apparatus provided in an embodiment of the present disclosure. As shown in FIG. 6, the apparatus 600 includes:
an obtaining module 610, configured to obtain a first bilingual sentence pair, in which the first bilingual sentence pair comprises a source language sentence and a target language sentence; and
a distilling module 620, configured to obtain a distilled second bilingual sentence pair by distilling a first language sentence in the first bilingual sentence pair based on a large language model (LLM), in which the first language sentence is the source language sentence or the target language sentence.

In some implementations, the distilling module 620 is configured to:
determine a distillation target for the first bilingual sentence pair, in which the distillation target is translation distillation or polishing distillation;
obtain the distilled second bilingual sentence pair by distilling the first language sentence with the LLM according to the distillation target.

In some implementations, the distilling module 620 is configured to:
generate a prompt word of the LLM according to the distillation target and the first bilingual sentence pair;
obtain a third language sentence corresponding to the first language sentence by inputting the prompt word and at least one language sentence of the first bilingual sentence pairs into the LLM for distillation; and
generate the distilled second bilingual sentence pair based on a second language sentence in the first bilingual sentence pair and the third language sentence;
in which, in a case that the first language sentence is the source language sentence, the second language sentence is the target language sentence; or in a case that the first language sentence is the target language sentence, the second language sentence is the source language sentence.

In some implementations, the distilling module 620 is configured to:
determine the at least one language sentence to be input into the LLM from the first bilingual sentence pair according to the distillation target; and
input the prompt word and the at least one language sentence into the LLM for distillation.

In some implementations, the distilling module 620 is configured to:
in a case that the distillation target is the translation distillation, generate a first prompt word of the LLM according to the distillation target and the second language sentence in the first bilingual sentence pair.

In some implementations, the distilling module 620 is configured to:
in a case that the second language sentence is the source language sentence, determine the translation distillation to be a target language distillation; and
set the second language sentence as a language sentence to be translated, and generate the first prompt word for translating the language sentence to be translated into a target language.

In some implementations, the distilling module 620 is configured to:
in a case that the second language sentence is the target language sentence, determine the translation distillation to be a source language distillation; and
set the second language sentence as a language sentence to be translated, and generate the first prompt word for translating the language sentence to be translated into a source language.

In some implementations, the distilling module 620 is configured to:
determine the second language sentence from the first bilingual sentence pair as a language sentence to be input into the LLM.

In some implementations, the distilling module 620 is configured to:
in a case that the distillation target is the polishing distillation, generate a second prompt word of the LLM according to the distillation target and the first language sentence.

In some implementations, the distilling module 620 is configured to:
set the first language sentence as a language sentence to be polished, and generate the second prompt word for polishing the language sentence to be polished.

In some implementations, the distilling module 620 is configured to:
determine first language sentence and the second language sentence in the first bilingual sentence pair as language sentences to be input into the LLM.

In some implementations, the distilling module 620 is configured to:
generate an enhanced corpus library by combining the distilled second bilingual sentence pair and the first bilingual sentence pair, and train a student model based on the enhanced corpus library, in which each corpus includes the source language sentence and the target language sentence.

In some implementations, the distilling module 620 is configured to:
perform quality assessment on each corpus in the enhanced corpus library;
obtain a target enhanced corpus library by performing screening on the corpus in the enhanced corpus according to quality assessment information of each corpus; and train the student model based on the target enhanced corpus library.

In some implementations, the distilling module 620 is configured to:
determine a corpus group corresponding to a same source language sentence;
screen at least one target corpus corresponding to the same source language sentence from the corpus group according to the quality assessment information of each corpus in the corpus group.

In some implementations, the distilling module 620 is configured to:
compare the quality assessment information of each corpus in the corpus group, and determining a corpus with a highest quality as the target corpus; or,
sort corpora in the corpus group according to the quality assessment information of each corpus in the corpus group, and select a corpus ranked at the top as the target corpus; or
compare the quality assessment information of each corpus in the corpus group with a preset quality assessment threshold, and select a corpus with quality assessment information greater than or equal to the preset quality assessment threshold as the target corpus.

In embodiments of the present disclosure, the first bilingual sentence pair including the source language sentence and the target language sentence is obtained, and the first bilingual sentence pair is distilled through the large language model to obtain the second bilingual sentence pair after distillation by the large language model. After the second bilingual sentence pair is distilled by the large language model, the translation effect and expression of the sentences are better, thereby ensuring the translation quality. The student model is trained based on the corpus library with better translation quality to ensure that the student model can learn the translation capability of the large language model and provide better translation effect.

In the technical solution of the disclosure, acquisition, storage and application of user personal information are in compliance with the provisions of relevant laws and regulations and do not violate public order and good morals.

According to embodiments of the disclosure, the present disclosure also provides an electronic device, a readable storage medium and a computer program product.

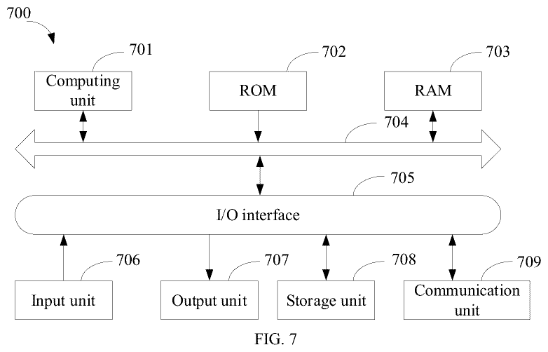

FIG. 7 is a block diagram of an electronic device 700 used to implement embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 7, the electronic device 700 includes a computing unit 701 that can perform various appropriate actions and processes based on computer programs stored in ROM (Read Only Memory) 702 or computer programs loaded from a storage unit 708 into RAM (Random Access Memory) 703. In RAM 703, various programs and data required for the operation of the device 700 can also be stored. The computing unit 701, ROM 702, and RAM 703 are connected to each other through a bus 704. The I/O (Input/Output) interface 705 is also connected to the bus 704.

Multiple components in device 700 are connected to the I/O interface 705, including input unit 706 such as keyboard, mouse, etc; output unit 707, such as various types of displays, speakers, etc; storage unit 708, such as disks, CDs, etc; and communication unit 709, such as network card, modem, wireless communication transceiver, etc. The communication unit 709 allows device 700 to exchange information/data with other devices through computer networks such as the Internet and/or various telecommunications networks.

The computing unit 701 can be various general-purpose and/or specialized processing components with processing and computing capabilities. Some examples of computing unit 701 include but are not limited to CPU (Central Processing Unit), GPU (Graphic Processing Units), various specialized AI (Artificial Intelligence) computing chips, various computing units that run machine learning model algorithms, DSP (Digital Signal Processor), and any suitable processor, controller, microcontroller, etc. The computing unit 701 executes various methods and processes described above, such as the training method for the full atomic structure prediction model. For example, in some embodiments, the training method for the full atomic structure prediction model may be implemented as a computer software program tangibly contained in a machine-readable medium, such as storage unit 708. In some embodiments, some or all of the computer program may be loaded and/or installed onto the device 700 via ROM 702 and/or communication unit 709. When the computer program is loaded into RAM 703 and executed by the computing unit 701, one or more steps of the training method for the full atomic structure prediction model described above can be performed. Alternatively, in other embodiments, the computing unit 701 may be configured to perform the training method for the full atomic structure prediction model through any other suitable means (e.g., with the aid of firmware).

Various embodiments of the systems and technologies described herein may be implemented in digital electronic circuit systems, integrated circuit systems, field programmable gate arrays (FPGAs), application specific integrated circuits (ASICs), application specific standard products (ASSPs), systems on chips (SOCs), load programmable logic devices (CPLDs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

The program codes used to implement the method of the present disclosure can be written in any combination of one or more programming languages. These program codes can be provided to processors or controllers of general-purpose computers, specialized computers, or other programmable data processing devices, so that when executed by the processor or controller, the program codes implement the functions/operations specified in the flowchart and/or block diagram. The program codes can be executed entirely on a machine, partially on a machine, partially on a machine as a standalone software package and partially on a remote machine, or entirely on a remote machine or server.

In the context of this disclosure, a machine readable medium may be a tangible medium that contains or stores programs for use by or in combination with an instruction execution system, apparatus, or device. The machine readable medium can be machine readable signal medium or machine readable storage medium. The machine readable medium may include, but are not limited to, electronic, magnetic, optical, electromagnetic, infrared, or semiconductor systems, devices, or equipment, or any suitable combination of the above. More specific examples of machine-readable storage medium include electrical connections based on one or more wires, portable computer disks, hard drives, RAM, ROM, EPROM (Electrically Programmable Read Only Memory) or flash memory, fiber optics, CD-ROM (Compact Disc Read Only Memory), optical storage devices, magnetic storage devices, or any suitable combination of the above.

In order to provide interaction with a user, the systems and techniques described herein may be implemented on a computer having a display device (e.g., a Cathode Ray Tube (CRT) or an LCD monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, intermediate computing components, or front-end components. The components of the system may be interconnected by any form or medium of digital data communication (e.g., a communication network). Examples of communication networks include: a local area network (LAN), a wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

1. An information processing method, comprising:
obtaining a first bilingual sentence pair, wherein the first bilingual sentence pair comprises a source language sentence and a target language sentence; and
obtaining a distilled second bilingual sentence pair by distilling a first language sentence in the first bilingual sentence pair based on a large language model (LLM), wherein the first language sentence is the source language sentence or the target language sentence.

2. The method according to claim 1, wherein obtaining the distilled second bilingual sentence pair by distilling the first language sentence in the first bilingual sentence pair based on the LLM comprises:
determining a distillation target for the first bilingual sentence pair, wherein the distillation target is translation distillation or polishing distillation;
obtaining the distilled second bilingual sentence pair by distilling the first language sentence with the LLM according to the distillation target.

3. The method according to claim 2, wherein obtaining the distilled second bilingual sentence pair by distilling the first language sentence with the LLM according to the distillation target comprises:
generating a prompt word of the LLM according to the distillation target and the first bilingual sentence pair;
obtaining a third language sentence corresponding to the first language sentence by inputting the prompt word and at least one language sentence of the first bilingual sentence pairs into the LLM for distillation; and
generating the distilled second bilingual sentence pair based on a second language sentence in the first bilingual sentence pair and the third language sentence;
wherein, in a case that the first language sentence is the source language sentence, the second language sentence is the target language sentence; or in a case that the first language sentence is the target language sentence, the second language sentence is the source language sentence.

4. The method according to claim 3, wherein inputting the prompt word and at least one language sentence of the first bilingual sentence pairs into the LLM for distillation comprises:
determining the at least one language sentence to be input into the LLM from the first bilingual sentence pair according to the distillation target; and
inputting the prompt word and the at least one language sentence into the LLM for distillation.

5. The method according to claim 3, wherein generating the prompt word of the LLM according to the distillation target and the first bilingual sentence pair comprises:
in a case that the distillation target is the translation distillation, generating a first prompt word of the LLM according to the distillation target and the second language sentence in the first bilingual sentence pair.

6. The method according to claim 5, wherein generating the first prompt word of the LLM according to the distillation target and the second language sentence in the first bilingual sentence pair comprises:
in a case that the second language sentence is the source language sentence, determining the translation distillation to be a target language distillation; and
setting the second language sentence as a language sentence to be translated, and generating the first prompt word for translating the language sentence to be translated into a target language.

7. The method according to claim 5, wherein generating the first prompt word of the LLM according to the distillation target and the second language sentence in the first bilingual sentence pair comprises:
in a case that the second language sentence is the target language sentence, determining the translation distillation to be a source language distillation; and
setting the second language sentence as a language sentence to be translated, and generating the first prompt word for translating the language sentence to be translated into a source language.

8. The method according to claim 5, wherein determining the at least one language sentence to be input into the LLM from the first bilingual sentence pair according to the distillation target comprises:
determining the second language sentence from the first bilingual sentence pair as a language sentence to be input into the LLM.

9. The method according to claim 3, wherein generating the prompt word of the LLM according to the distillation target and the first language sentence pair comprises:
in a case that the distillation target is the polishing distillation, generating a second prompt word of the LLM according to the distillation target and the first language sentence.

10. The method according to claim 9, wherein generating the second prompt word of the LLM according to the distillation target and the first language sentence comprises:
setting the first language sentence as a language sentence to be polished, and generating the second prompt word for polishing the language sentence to be polished.

11. The method according to claim 9, wherein determining the at least one language sentence to be input into the LLM from the first bilingual sentence pair according to the distillation target comprises:
determining first language sentence and the second language sentence in the first bilingual sentence pair as language sentences to be input into the LLM.

12. The method according to claim 1, after obtaining the distilled second bilingual sentence pair by distilling the first language sentence in the first bilingual sentence pair based on the LLM, further comprising:
generating an enhanced corpus library by combining the distilled second bilingual sentence pair and the first bilingual sentence pair, and training a student model based on the enhanced corpus library, wherein each corpus comprises the source language sentence and the target language sentence.

13. The method according to claim 12, wherein training the student model based on the enhanced corpus library comprises:
performing quality assessment on each corpus in the enhanced corpus library;
obtaining a target enhanced corpus library by performing screening on the corpus in the enhanced corpus according to quality assessment information of each corpus; and
training the student model based on the target enhanced corpus library.

14. The method according to claim 13, wherein obtaining the target enhanced corpus library by performing screening on the corpus in the enhanced corpus according to quality assessment information of the corpus comprises:
determining a corpus group corresponding to a same source language sentence;
screening at least one target corpus corresponding to the same source language sentence from the corpus group according to the quality assessment information of each corpus in the corpus group.

15. The method according to claim 14, wherein screening at least one target corpus corresponding to the same source language sentence from the corpus group according to the quality assessment information of each corpus in the corpus group comprises:
comparing the quality assessment information of each corpus in the corpus group, and determining a corpus with a highest quality as the target corpus; or,
sorting corpora in the corpus group according to the quality assessment information of each corpus in the corpus group, and selecting a corpus ranked at the top as the target corpus; or
comparing the quality assessment information of each corpus in the corpus group with a preset quality assessment threshold, and selecting a corpus with quality assessment information greater than or equal to the preset quality assessment threshold as the target corpus.

16. An electronic device comprising:
at least one processor; and
a memory communicatively coupled to the at least one processor; wherein,
the memory stores instructions executable by the at least one processor, when the instructions are executed by the at least one processor, the at least one processor is configured to:
obtain a first bilingual sentence pair, wherein the first bilingual sentence pair comprises a source language sentence and a target language sentence; and
obtain a distilled second bilingual sentence pair by distilling a first language sentence in the first bilingual sentence pair based on a large language model (LLM), wherein the first language sentence is the source language sentence or the target language sentence.

17. The electronic device according to claim 16, wherein the at least one processor is configured to:
determine a distillation target for the first bilingual sentence pair, wherein the distillation target is translation distillation or polishing distillation;
obtain the distilled second bilingual sentence pair by distilling the first language sentence with the LLM according to the distillation target.

18. The electronic device according to claim 17, wherein the at least one processor is configured to:
generate a prompt word of the LLM according to the distillation target and the first bilingual sentence pair;
obtain a third language sentence corresponding to the first language sentence by inputting the prompt word and at least one language sentence of the first bilingual sentence pairs into the LLM for distillation; and
generate the distilled second bilingual sentence pair based on a second language sentence in the first bilingual sentence pair and the third language sentence;
wherein, in a case that the first language sentence is the source language sentence, the second language sentence is the target language sentence; or in a case that the first language sentence is the target language sentence, the second language sentence is the source language sentence.

19. A non-transitory computer-readable storage medium having computer instructions stored thereon, wherein the computer instructions are configured to enable a computer to implement the method comprising:
obtaining a first bilingual sentence pair, wherein the first bilingual sentence pair comprises a source language sentence and a target language sentence; and
obtaining a distilled second bilingual sentence pair by distilling a first language sentence in the first bilingual sentence pair based on a large language model (LLM), wherein the first language sentence is the source language sentence or the target language sentence.

20. A computer program product comprising computer programs, wherein when the computer programs are executed by a processor, steps of the method according to claim 1 are implemented.
